(19) United States
(12) Patent Application Publication
(10) Pub. No.: US 2018/0300122 A1
(43) Pub. Date: Oct. 18, 2018

(54) DATA PROCESSING METHOD AND SYSTEM, AND SERVER

(71) Applicant: BEIJING KINGSOFT INTERNET SECURITY SOFTWARE CO., LTD., Beijing (CN)

(72) Inventor: Sini He, Beijing (CN)

(73) Assignee: BEIJING KINGSOFT INTERNET SECURITY SOFTWARE CO., L TD., Beijing (CN)

(21) Appl. No.: 15/955,164

(22) Filed: Apr. 17, 2018

(30) Foreign Application Priority Data
Apr. 18, 2017 (CN) 201710254052.5

(51) Int. Cl. G06F 8/65

(52) U.S. Cl. CPC G06F 8/65

(57) ABSTRACT

Embodiments of the present disclosure provide a data processing method and system, and a server. The method includes operations of obtaining application function modification information with regard to a terminal application, generating an application modification data string including application function identifier and application function status information, and sending the application modification data string to a terminal, so that the terminal finds an application function of the terminal application indicated by the application function identifier, and modifies function status of the application function based on the application function status information.

### CROSS-REFERENCE TO RELATED APPLICATIONS

This application is based on and claims a priority to Chinese Patent Application No. 201710254052.5, filed on Apr. 18, 2017, the entire contents of which are incorporated herein by reference.

### FIELD

The present disclosure relates to a computer technology field, and more particularly, to a data processing method, a data processing system and a server.

### BACKGROUND

With continuous development and improvement of computer technology, terminal devices such as mobile phones and tablet PCs have become an indispensable part of people's lives. Various terminal applications in the terminal can meet different needs of users, such as instant messaging and multimedia browsing. In a process of using the terminal, some application functions in the terminal application need to change their functional states according to actual needs of the user. For example, when a weather application is installed in the terminal device, and then a weather reminder function as an unnecessary application function in a social application can be disabled. In the related art, the terminal device can change states of some application functions by downloading and upgrading new terminal application versions. However, since an operation process of downloading and upgrading the terminal application of new version is tedious and the download process takes a long time, an operation complexity of changing the state of the application function is increased, and an efficiency of changing the state is affected.

### SUMMARY

Embodiments of the present disclosure provide a data processing method, a data processing system, a terminal and a server.

A first aspect of embodiments of the present disclosure provides a data processing method. The method may include: obtaining application function modification information with regard to a terminal application, in which, the application function modification information includes the application function identifier and application function status information; generating an application modification data string including the application function identifier and the application function status information; and sending the application modification data string to a terminal, so that the terminal finds an application function of the terminal application indicated by the application function identifier, and modifies function status of the application function based on the application function status information.

A second aspect of embodiments of the present disclosure provides a data processing method. The method may include: receiving an application modification data string with regard to a terminal application sent by a server; finding an application function of the terminal application indicated by an application function identifier included in the application modification data string; and modifying function status of the application function based on the function status information included in the application modification data string.

A third aspect of embodiments of the present disclosure provides a server. The server may include an information obtaining unit, a data string generating unit and a data string sending unit.

The information obtaining unit is configured to obtain application function modification information with regard to a terminal application, in which, the application function modification information includes an application function identifier and application function status information.

The data string generating unit is configured to generate an application modification data string including the application function identifier and the application function status information.

The data string sending unit is configured to send the application modification data string to a terminal, so that the terminal finds an application function of the terminal application indicated by the application function identifier, and modifies function status of the application function based on the application function status information.

A fourth aspect of embodiments of the present disclosure provides a terminal. The terminal may include a data string receiving unit, an application function finding unit and a function status modifying unit.

The data string receiving unit is configured to receive an application modification data string with regard to a terminal application sent by a server.

The application function fmding unit is configured to find an application function of the terminal application indicated by an application function identifier included in the application modification data string.

The function status modifying unit is configured to modify function status of the application function based on the function status information included in the application modification data string.

A fifth aspect of embodiments of the present disclosure provides a data processing system. The data processing system may include the server according to the third aspect and the terminal according to the fourth aspect.

### BRIEF DESCRIPTION OF THE DRAWINGS

In order to clearly illustrate technical solutions of embodiments of the present disclosure, a brief description of drawings used in embodiments is given below. Obviously, the drawings in the following descriptions are only part embodiments of the present disclosure, and for those skilled in the art, other drawings can be obtained according to these drawings without creative labor.

FIG. 1 is a flow chart of a data processing method according to an embodiment of the present disclosure;

FIG. 2 is a flow chart of a data processing method according to another embodiment of the present disclosure;

FIG. 3 is a flow chart of a data processing method according to another embodiment of the present disclosure;

FIG. 4 is a flow chart of a data processing method according to another embodiment of the present disclosure;

FIG. 5 is a flow chart of a data processing method according to another embodiment of the present disclosure;

FIG. 6 is a block diagram of a server according to an embodiment of the present disclosure;

FIG. 7 is a block diagram of a server according to another embodiment of the present disclosure;

FIG. 8 is a block diagram of a data string sending unit according to an embodiment of the present disclosure;

FIG. 9 is a block diagram of a terminal according to an embodiment of the present disclosure;

FIG. 10 is a block diagram of a terminal according to another embodiment of the present disclosure;

FIG. 11 is a block diagram of a function status modifying unit according to an embodiment of the present disclosure;

FIG. 12 is a block diagram of a terminal according to another embodiment of the present disclosure;

FIG. 13 is a schematic diagram of a data processing system according to an embodiment of the present disclosure.

### DETAILED DESCRIPTION

Reference will be made clearly and completely to technical solutions in the embodiments of the present disclosure with accompanying drawings. Obviously, the embodiments described here are only part of the embodiments of the present disclosure and are not all embodiments of the present disclosure. Based on the embodiments of the present disclosure, other embodiments obtained by those skilled in the art without creative labor are within scope of the present disclosure.

The data processing method provided by embodiments of the present disclosure may be applied to a scene where the terminal changes an application function status in a terminal application without performing a version upgrade. For example, the server obtains application function modification information with regard to the terminal application, in which, the application function modification information includes application function identifier and application function status information, the server generates application modification data string including the application function identifier and the application function status information, and sends the application modification data string to the terminal, so that the terminal finds an application function of the terminal application indicated by the application function identifier, and modifies the function status of the application function based on the application function status information. The terminal parses the application modification data string sent by the server, and modifies the state of the application function according the parsed application function identifier and the application function status information, thereby reducing the operation complexity of changing the state of the application function, and improving the efficiency of changing the state.

The terminal involved in embodiments of the present disclosure may be a terminal device with networking functions such as a tablet PC, a smart phone, a palm computer and a mobile internet device (MID). The server may be a device capable of receiving and sending data and of providing computer services in response to service requests.

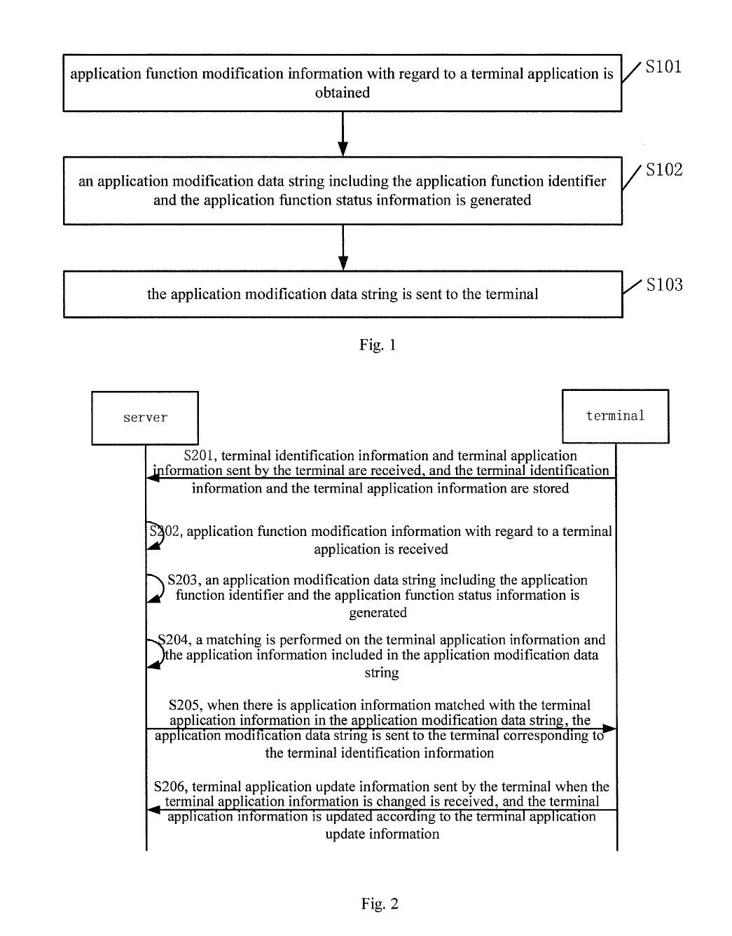

The data processing method provided by embodiments of the present disclosure will be described in detail with reference to accompanying FIG. 1 to FIG. 4.

Referring to FIG. 1, a flow chart of a data processing method according to an embodiment of the present disclosure is illustrated. As illustrated in FIG. 1, acts of the data processing method according to embodiments of the present disclosure are described from a server side. The method includes block S101 to block S103.

At block S101, application function modification information with regard to a terminal application is obtained.

In this embodiment, the server can obtain the application function modification information with regard to the terminal application. It may be understood that, the application function modification information may be information for modifying the application function in the terminal application when a background developer upgrades a version of the terminal application or maintains the terminal application. For example, the application function modification information may be information that controls a video chat function in a social application to be enabled, or may be information that controls a weather application function in the social application to be displayed to a user every three hours.

It may be understood that, the application function modification information may include application function identifier and application function status information. The application function identifier may be information that indicates the application function of the terminal application. For example, “weather” may be an application function identifier included in the application function modification information that indicates the weather application function in the social application. The application function status information may be information that represents the state of the application function in the terminal application. For example, “false” may represent information of a disabled state of the weather application function in the social application, and “show” may represent information of displaying the weather application function in the social application.

At block S102, an application modification data string including the application function identifier and the application function status information is generated.

In this embodiment, the server can generate the application modification data string that includes the application function identifier and the application function status information. It may be understood that, the application modification data string may be a data string sent by the server to the terminal for modifying the application function in a corresponding terminal application in the terminal. For example, an application modification data string “social application A, weather, false” may indicate to disable the weather application function in the social application A in the terminal.

In at least one embodiment, the application modification data string may further include application information that indicates the terminal application in the terminal. The application information may be version information that indicates a version of the terminal application, or information that indicates a time frequency or a change location for changing the state of the application function. For example, an application modification data string “V1.3, social application A, weather, false” that includes the terminal application version information may indicate to disable the weather application function in the social application A with the version 1.3, and an application modification data string “≥V1.3, social application A, weather, false” may indicate to disable the weather application function in the social application A with the version higher than or equal to 1.3. The application modification data string “social application A, America, weather, false” that includes the application function change location may indicate to disable the weather application function in the social application A of an American client. The application modification data string “social application A, 3h, weather, show” that includes the application function change time frequency may indicate to display the weather application function every three hours in the social application A.

It should be noted that, a content in the application modification data string may be generated in a format that is agreed with the terminal. After the terminal receives the application modification data string, the terminal can parse the data content in the application modification data string.

At block S103, the application modification data string is sent to the terminal. In this embodiment, the server can send the application modification data string to the terminal.

In addition, after the terminal receives the application modification data string, the terminal can find an application function of the terminal application indicated by the application function identifier, and can modify function status of the application function based on the application function status information.

In embodiments of the present disclosure, the server obtains the application function modification information with regard to the terminal application, in which, the application function modification information includes the application function identifier and the application function status information, and generates the application modification data string including the application function identifier and the application function status information, and then sends the application modification data string to the terminal, so that the terminal finds the application function of the terminal application indicated by the application function identifier, and modifies the function status of the application function based on the application function status information. The terminal parses the application modification data string sent by the server, and modifies the state of the application function according to the parsed application function identifier and the application function status information, thereby reducing the operation complexity of changing the state of the application function, and improving the efficiency of changing the state.

Referring to FIG. 2, a flow chart of a data processing method according to another embodiment of the present disclosure is illustrated. As illustrated in FIG. 2, acts of the data processing method according to embodiments of the present disclosure are described from the server side. The method includes block S201 to block S206.

At block S201, terminal identification information and terminal application information sent by a terminal are received, and the terminal identification information and the terminal application information are stored.

In this embodiment, the server can receive the terminal identification information and the terminal application information sent by the terminal. It may be understood that, the terminal identification information may be the information that can prove the identity of the terminal. For example, the terminal identification information may be user identification information (for example, the access information “ID: XXX” of the terminal device). The terminal application information may be version information of the terminal application, location information of the terminal device located by the terminal application, or the like.

In addition, the server can store the terminal identification information and the terminal application information.

At block S202, application function modification information with regard to a terminal application is received.

In this embodiment, the server can obtain the application function modification information with regard to the terminal application. It may be understood that, the application function modification information may be information for modifying the application function in the terminal application when a background developer upgrades a version of the terminal application or maintains the terminal application. For example, the application function modification information may be information that controls the video chat function in the social application to be enabled, or may be information that controls the weather application function in the social application to be displayed to the user every three hours.

It may be understood that, the application function modification information may include the application function identifier and the application function status information. The application function identifier may be information that indicates the application function of the terminal application. For example, “weather” may be an application function identifier included in the application function modification information that indicates the weather application function in the social application. The application function status information may be information that represents the state of the application function in the terminal application. For example, “false” may represent information of a disabled state of the weather application function in the social application, and “show” may represent information of displaying the weather application function in the social application.

At block S203, an application modification data string including the application function identifier and the application function status information is generated.

In this embodiment, the server can generate the application modification data string that includes the application function identifier and the application function status information. It may be understood that, the application modification data string may be the data string that the server sends to the terminal to modify the application function in a corresponding terminal application in the terminal. For example, the application modification data string “social application A, weather, false” may indicate to disable the weather application function in the social application A in the terminal.

In at least one embodiment, the application modification data string may further include application information that indicates the terminal application in the terminal. The application information may be version information that indicates a version of the terminal application, or information that indicates time frequency or change location for changing the state of the application function. For example, the application modification data string “V1.3, social application A, weather, false” that includes the terminal application version information may indicate to disable the weather application function in the social application A with the version 1.3, and the application modification data string “≥V1.3, social application A, weather, false” may indicate to disable the weather application function in the social application A with the version higher than or equal to 1.3. The application modification data string “social application A, America, weather, false” that includes the application function change location may indicate to disable the weather application function in the social application A of the American client. The application modification data string “social application A, 3h, weather, show” that includes the application function change time frequency may indicate to display the weather application function every three hours in the social application A.

It should be noted that, the content in the application modification data string may be generated in the format that is agreed with the terminal. After the terminal receives the application modification data string, the terminal can parse the data content in the application modification data string.

At block S204, a matching is performed on the terminal application information and the application information included in the application modification data string.

In this embodiment, when the application modification data string includes the application information, the server can match the terminal application information with the application information included in the application modification data string. It may be understood that, the application modification data string may include application information corresponding to the application function modification information. The application information may be the version information of the terminal application, the terminal location information, or the like. For example, for an application modification data string “V2.0, public service application A, Shanghai, wallet payment, open”, “V2,0” and “Shanghai” can be configured as the application information included in the application modification data string.

It may be understood that, the terminal application information may be sent by the terminal and stored by the server at block S201. Since the terminal application information includes at least one of the application version information and the terminal location information, the server may use the terminal application information to match the application information included in the application modification data string.

At block S205, when there is application information matched with the terminal application information in the application modification data string, the application modification data string is sent to the terminal corresponding to the terminal identification information.

In this embodiment, when there is the application information matched with the terminal application information in the application modification data string, the server can send the application modification data string to the terminal corresponding to the terminal identification information. For example, when the application version information indicated by the terminal application information is “V2.0” and the terminal location information is “Shanghai”, when the application information in the application modification data string also includes “V2.0” and “Shanghai”, it may indicate that there is the application information matched with the terminal application information in the application modification data string. It may be understood that, the server can send the application modification data string “V2.0, public service application A, Shanghai, wallet payment, open” to the terminal whose user identification information is “ID: XXX”.

In embodiments of the present disclosure, when the application information in the application modification data string matches with the terminal application information stored in the server, the server can send the application modification data string to the terminal corresponding to the terminal identification information, so as to avoid sending the application modification data string to a mismatched terminal, thus improving the working efficiency of the server sending the application modification data string.

At block S206, terminal application update information sent by the terminal when the terminal application information is changed is received, and the terminal application information is updated according to the terminal application update information.

In this embodiment, the server can receive the terminal application update information sent by the terminal when the terminal application information is changed. It may be understood that, the application update information may be information obtained by the terminal when the application information of the terminal application is changed. For example, when the version information of the terminal application is upgraded from “V2.0” to “V2.1”, and then “V2.1” is configured as the application update information at this moment, and when the location information of the terminal application is changed from “Shanghai” to “Chongqing”, and then “Chongqing” is configured as the application update information at this moment. In addition, the server can update the stored terminal application information according to the terminal application update information. For example, the server can replace previously stored version information “V2.0” with the version information “V2.1”, or replace previously stored location information “Shanghai” with the terminal location information “Chongqing”.

In at least one embodiment, the terminal can obtain the current terminal application information every certain time period (for example, every an hour) and send it to the server. When the current terminal application information is not changed compared with the terminal application information stored in the server, the server may not perform an operation on the terminal application information. When the current terminal application information is changed compared with the terminal application information stored in the server, the changed information is configured as the terminal application update information, and the server may update the stored terminal application information according to the terminal application update information.

In at least one embodiment, the terminal sends the terminal application update information to the server only when the terminal application information is changed, so that the server may update the stored terminal application information according to the terminal application update information.

In embodiments of the present disclosure, the server receives the terminal application update information sent by the terminal and updates the stored terminal application information, so as to prevent the server from sending the application modification data string that is not match with the current terminal application information of the terminal application to the terminal, thus reducing the probability that the server sends the application modification data string in error.

In embodiments of the present disclosure, the server obtains the application function modification information with regard to the terminal application, in which, the application function modification information includes the application function identifier and the application function status information, and generates the application modification data string including the application function identifier and the application function status information, and then sends the application modification data string to the terminal, so that the terminal finds the application function of the terminal application indicated by the application function identifier, and modifies the function status of the application function based on the application function status information. The terminal parses the application modification data string sent by the server, and modifies the state of the application function according to the parsed application function identifier and the application function status information, thereby reducing the operation complexity of changing the state of the application function, and improving the efficiency of changing the state. By matching the terminal application information with the application information in the application modification data string, the server avoids sending the application modification data string to the mismatched terminal, thus improving the working efficiency of sending the application modification data string. The server updates the stored terminal application information based on the terminal application update information, so as to avoid sending the application modification data string that is not matched with the current terminal application information of the terminal application to the terminal, thus reducing the probability of sending application modification data string in error.

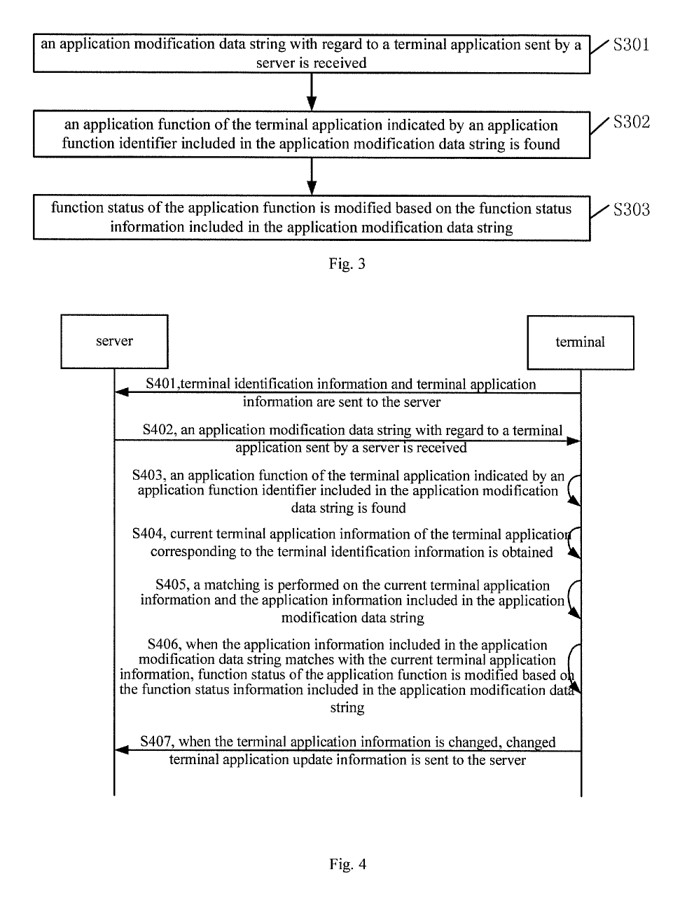

Referring to FIG. 3, a flow chart of a data processing method according to another embodiment of the present disclosure is illustrated. As illustrated in FIG. 3, acts of the data processing method according to embodiments of the present disclosure are described from a terminal side. The method includes block S301 to block S303.

At block S301, an application modification data string with regard to a terminal application sent by a server is received.

In this embodiment, the terminal can receive the application modification data string with regard to the terminal application sent by the server. It may be understood that, the application modification data string may be generated by the server based on application function identifier and application function status information. The application function modification information with regard to the terminal application obtained by the server may include the application function identifier and the application function status information.

It may be understood that, the application function modification information may be information for modifying the application function in the terminal application when a background developer upgrades a version of the terminal application or maintains the terminal application. For example, the application function modification information may be information that controls the video chat function in the social application to be enabled, or may be information that controls the weather application function in the social application to be displayed to the user every three hours.

It may be understood that, the application function identifier may be information that indicates the application function of the terminal application. For example, “weather” may be an application function identifier included in the application function modification information that indicates the weather application function in the social application. The application function status information may be information that represents the state of the application function in the terminal application. For example, “false” may represent information of the disabled state of the weather application function in the social application, and “show” may represent information of displaying the weather application function in the social application.

It should be noted that, the content in the application modification data string may be generated in the format that is agreed with the terminal. After the terminal receives the application modification data string, the terminal can parse the data content in the application modification data string. For example, from the application modification data string “V1.3, shopping application A, pay, false”, the terminal can parse out content “disabling the payment application function in the shopping application A with the version 1.3”.

At block S302, an application function of the terminal application indicated by an application function identifier included in the application modification data string is found.

In this embodiment, the terminal can find the application function of the terminal application indicated by the application function identifier included in the application modification data string. It may be understood that, the application function identifier may indicate the application function of the terminal application. For example, an application function identifier “pay” may indicate the payment application function of the shopping application.

At block S303, function status of the application function is modified based on the function status information included in the application modification data string.

In this embodiment, the terminal can modify the function status of the application function based on the function status information included in the application modification data string. For example, when the function status information is “false”, the terminal can modify the function status of the application function to be “false” based on this function status information.

In embodiments of the present disclosure, the terminal receives the application modification data string with regard to the terminal application sent by the server, and fmds the application function of the terminal application indicated by the application function identifier included in the application modification data string, and then modifies the function status of the application function based on the function status information included in the application modification data string. The terminal parses the application modification data string sent by the server, and modifies the state of the application function according to the parsed application function identifier and the application function status information, thereby reducing the operation complexity of changing the state of the application function, and improving the efficiency of changing the state.

Referring to FIG. 4, a flow chart of a data processing method according to another embodiment of the present disclosure is illustrated. As illustrated in FIG. 4, acts of the data processing method according to embodiments of the present disclosure are described from the terminal side. The method includes block S401 to block S407.

At block S401, terminal identification information and terminal application information are sent to the server.

In this embodiment, the terminal can send the terminal identification information and the terminal application information to the server. It may be understood that, the terminal identification information may be information that can prove the identity of the terminal. For example, the terminal identification information may be user identification information (for example, the access information “ID: XXX” of the terminal device). The terminal application information may be the version information of the terminal application, the location information of the terminal device located by the terminal application, or the like.

In addition, the server can store the terminal identification information and the terminal application information.

At block S402, an application modification data string with regard to a terminal application sent by a server is received.

In this embodiment, the terminal can receive the application modification data string with regard to the terminal application sent by the server. It may be understood that, the application modification data string may be generated by the server based on the application function identifier and application function status information. The application function modification information with regard to the terminal application obtained by the server may include the application function identifier and the application function status information.

It may be understood that, the application function modification information may be information for modifying the application function in the terminal application when a background developer upgrades a version of the terminal application or maintains the terminal application. For example, the application function modification information may be information that controls the video chat function in the social application to be enabled, or may be information that controls the weather application function in the social application to be displayed to the user every three hours.

It may be understood that, the application function identifier may be information that indicates the application function of the terminal application. For example, “weather” may be an application function identifier included in the application function modification information that indicates the weather application function in the social application. The application function status information may be information that represents the state of the application function in the terminal application. For example, “false” may represent information of the disabled state of the weather application function in the social application, and “show” may represent information of displaying the weather application function in the social application.

It should be noted that, the content in the application modification data string may be generated in the format that is agreed with the terminal. After the terminal receives the application modification data string, the terminal can parse the data content in the application modification data string. For example, from the application modification data string “V1.3, shopping application A, pay, false”, the terminal can parse out content “disabling the payment application function in the shopping application A with the version 1.3”.

At block S403, an application function of the terminal application indicated by an application function identifier included in the application modification data string is found.

In this embodiment, the terminal can find the application function of the terminal application indicated by the application function identifier included in the application modification data string.

It may be understood that, the application function identifier may indicate the application function of the terminal application. For example, the application function identifier “pay” may indicate the payment application function of the shopping application.

At block S404, current terminal application information of the terminal application corresponding to the terminal identification information is obtained.

In this embodiment, the terminal can obtain the current terminal application information of the terminal application corresponding to the terminal identification information. It may be understood that, the terminal identification information may include the application identifier of the terminal application that identifies the identity of the terminal application (for example, different terminal applications correspond to different package names, and ‘corn. xxx. shejiao’ may be used as the application identifier of the social application).

It may be understood that, when the terminal identification information is the application identifier that indicates the social application A, the terminal can obtain current terminal application information of the social application A. The current terminal application information may be the version information of the social application A or the location information of the terminal.

At block S405, a matching is performed on the current terminal application information and the application information included in the application modification data string.

In this embodiment, the terminal can match the current terminal application information with the application information included in the application modification data string. It may be understood that, the terminal may match the two by finding whether there is application information that is consistent with the current terminal application information in the application modification data string.

At block S406, when the application information included in the application modification data string matches with the current terminal application information, function status of the application function is modified based on the function status information included in the application modification data string.

In this embodiment, when the application information included in the application modification data string is matched with the current terminal application information, the terminal can modify the function status of the application function based on the function status information included in the application modification data string. For example, when the current terminal application information is “V2.0” and “Shanghai”, and the application information included in the application modification data string also includes “V2.0” and “Shanghai”, and then the application information included in the application modification data string is matched with the current terminal application information.

In addition, the terminal can modify the function status of the application function based on the function status information included in the application modification data string. For example, when the function status information is “false”, the terminal can modify the function status of the application function to be “false” based on this function status information.

In embodiments of the present disclosure, when the current terminal application information of the terminal application is matched with the application information included in the application modification data string, the terminal modifies the function status of the application function based on the function status information included in the application modification data string, thereby reducing the probability that the terminal modifies the application function of the terminal application in error.

At block S407, when the terminal application information is changed, terminal application update information is sent to the server.

In this embodiment, when the terminal application information is changed, the terminal can send the changed terminal application update information to the server. It may be understood that, the application update information may be information obtained by the terminal when the application information of the terminal application is changed. For example, when the version information of the terminal application is upgraded from “V2.0” to “V2.1”, and then “V2.1” is configured as the application update information at this moment, and when the location information of the terminal application is changed from “Shanghai” to “Chongqing”, and then “Chongqing” is configured as the application update information at this moment.

In addition, the server can update the stored terminal application information according to the terminal application update information. For example, the server can replace previously stored version information “V2.0” with the version information “V2.1”, or replace previously stored location information “Shanghai” with the terminal location information “Chongqing”.

In at least one embodiment, the terminal can obtain the current terminal application information every certain time period (for example, every an hour) and send it to the server. When the current terminal application information is not changed compared with the terminal application information stored in the server, the server may not perform the operation on the terminal application information. When the current terminal application information is changed compared with the terminal application information stored in the server, the changed information is configured as the terminal application update information, and the server may update the stored terminal application information according to the terminal application update information.

In at least one embodiment, the terminal sends the terminal application update information to the server only when the terminal application information is changed, so that the server may update the stored terminal application information according to the terminal application update information.

In embodiments of the present disclosure, the terminal sends the terminal application update information to the server, so that the server can update the stored terminal application information, thereby preventing the server from sending the application modification data string that is not matched with the current terminal application information of the terminal application to the terminal, and reducing the probability that the server sends the application modification data string in error.

In embodiments of the present disclosure, the terminal receives the application modification data string with regard to the terminal application sent by the server, and finds the application function of the terminal application indicated by the application function identifier included in the application modification data string, and then modifies the function status of the application function based on the function status information included in the application modification data string. The terminal parses the application modification data string sent by the server, and modifies the state of the application function according to the parsed application function identifier and the application function status information, thereby reducing the operation complexity of changing the state of the application function and improving the efficiency of changing the state. The terminal modifies the function status of the application function based on the function status information only when the current terminal application information of the terminal application is matched with the application information included in the application modification data string, thereby reducing the probability that the terminal modifies the application function of the terminal application in error. The terminal sends the terminal application update information to the server, so that the server can update the stored terminal application information, thereby preventing the server from sending the application modification data string that is not matched with the current terminal application information of the terminal application to the terminal, and reducing the probability that the server sends the application modification data string in error.

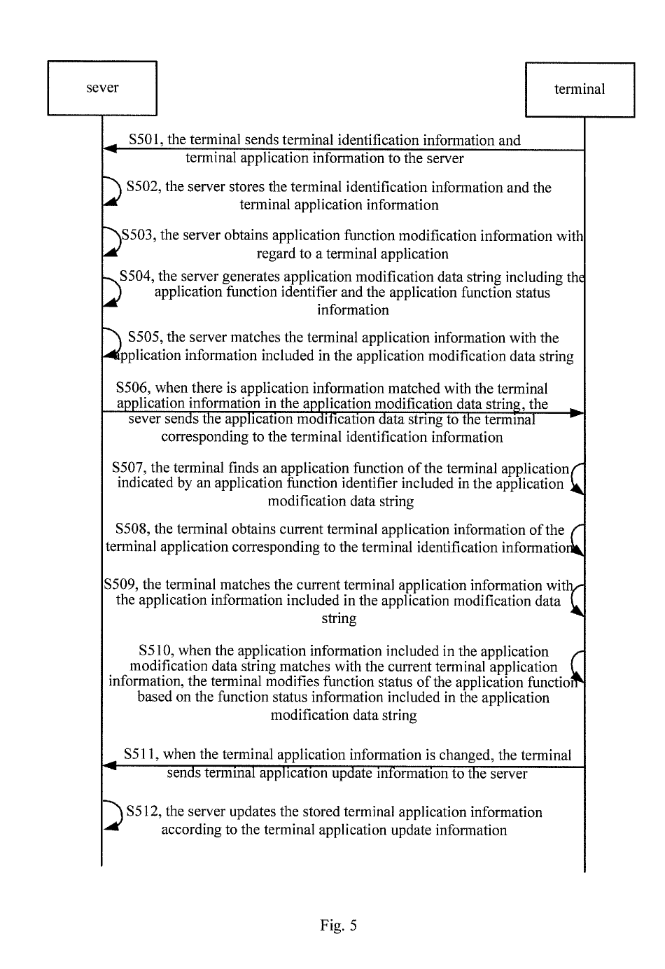

Referring to FIG. 5, a flow chart of a data processing method according to another embodiment of the present disclosure is illustrated. As illustrated in FIG. 5, acts of the data processing method according to embodiments of the present disclosure are described from the server side and the terminal side. The method includes block S501 to block S511.

At block S501, the terminal sends terminal identification information and terminal application information to the server.

In this embodiment, the terminal can send the terminal identification information and the terminal application information to the server. It may be understood that, the terminal identification information may be the information that can prove the identity of the terminal. For example, the terminal identification information may be the user identification information (for example, the access information “ID: XXX” of the terminal device). The terminal application information may be the version information of the terminal application, the location information of the terminal device located by the terminal application, or the like.

At block S502, the server stores the terminal identification information and the terminal application information.

In this embodiment, the server can receive the terminal identification information and the terminal application information sent by the terminal, and store the terminal identification information and the terminal application information.

At block S503, the server obtains application function modification information with regard to a terminal application.

In this embodiment, the server can obtain the application function modification information with regard to the terminal application. It may be understood that, the application function modification information may be information for modifying the application function in the terminal application when a background developer upgrades a version of the terminal application or maintains the terminal application. For example, the application function modification information may be information that controls the video chat function in the social application to be enabled, or may be information that controls the weather application function in the social application to be displayed to the user every three hours.

It may be understood that, the application function modification information may include the application function identifier and the application function status information. The application function identifier may be information that indicates the application function of the terminal application. For example, “weather” may be an application function identifier included in the application function modification information that indicates the weather application function in the social application. The application function status information may be information that represents the state of the application function in the terminal application. For example, “false” may represent information of a disabled state of the weather application function in the social application, and “show” may represent information of displaying the weather application function in the social application.

At block S504, the server generates application modification data string including the application function identifier and the application function status information.

In this embodiment, the server can generate the application modification data string that includes the application function identifier and the application function status information. It may be understood that, the application modification data string may be a data string that the server sends to the terminal to modify the application function in a corresponding terminal application in the terminal. For example, the application modification data string “social application A, weather, false” may indicate to disable the weather application function in the social application A in the terminal.

In at least one embodiment, the application modification data string may further include application information that indicates the terminal application in the terminal. The application information may be version information that indicates a version of the terminal application, or information that indicates time frequency or change location for changing the state of the application function. For example, the application modification data string “V1.3, social application A, weather, false” that includes the terminal application version information may indicate to disable the weather application function in the social application A with the version 1.3, and the application modification data string “ V1.3, social application A, weather, false” may indicate to disable the weather application function in the social application A with the version higher than or equal to 1.3. The application modification data string “social application A, America, weather, false” that includes the application function change location may indicate to disable the weather application function in the social application A of the American client. The application modification data string “social application A, 3h, weather, show” that includes the application function change time frequency may indicate to display the weather application function in the social application A every three hours.

It should be noted that, the content in the application modification data string may be generated in the format that is agreed with the terminal. After the terminal receives the application modification data string, the terminal can parse the data content in the application modification data string.

At block S505, the server matches the terminal application information with the application information included in the application modification data string.

In this embodiment, when the application modification data string includes the application information, the server can match the terminal application information with the application information included in the application modification data string. It may be understood that, the application modification data string may include application information corresponding to the application function modification information. The application information may be the version information of the terminal application, the terminal location information, or the like. For example, for the application modification data string “V2.0, public service application A, Shanghai, wallet payment, open”, “V2,0” and “Shanghai” can be configured as the application information included in the application modification data string.

It may be understood that, the terminal application information may be sent by the terminal and stored by the server at block S201. Since the terminal application information includes at least one of the application version information and the terminal location information, the server may use the terminal application information to match the application information included in the application modification data string.

At block S506, when there is application information matched with the terminal application information in the application modification data string, the sever sends the application modification data string to the terminal corresponding to the terminal identification information.

In this embodiment, when there is the application information matched with the terminal application information in the application modification data string, the server can send the application modification data string to the terminal corresponding to the terminal identification information. For example, when the application version information indicated by the terminal application information is “V2.0” and the terminal location information is “Shanghai”, when the application information in the application modification data string also includes “V2.0” and “Shanghai”, it may indicate that there is the application information matched with the terminal application information in the application modification data string. It may be understood that, the server can send the application modification data string “V2.0, public service application A, Shanghai, wallet payment, open” to the terminal whose user identification information is “ID: XXX”.

In this embodiment, when the application information in the application modification data string matches with the terminal application information stored in the server, the server can send the application modification data string to the terminal corresponding to the terminal identification information, so as to avoid sending the application modification data string to the mismatched terminal, thus improving the working efficiency of the server sending the application modification data string.

At block S507, the terminal finds an application function of the terminal application indicated by an application function identifier included in the application modification data string.

In this embodiment, the terminal can fmd the application function of the terminal application indicated by the application function identifier included in the application modification data string. It may be understood that, the application function identifier may indicate the application function of the terminal application. For example, the application function identifier “pay” may indicate the payment application function of the shopping application.

At block S508, the terminal obtains current terminal application information of the terminal application corresponding to the terminal identification information.

In this embodiment, the terminal can obtain the current terminal application information of the terminal application corresponding to the terminal identification information. It may be understood that, the terminal identification information may include the application identifier of the terminal application that identifies the identity of the terminal application (for example, different terminal applications correspond to different package names, and xxx. shejiao' may be used as the application identifier of the social application).

It may be understood that, when the terminal identification information is the application identifier that indicates the social application A, the terminal can obtain current terminal application information of the social application A. The current terminal application information may be the version information of the social application A or the location information of the terminal.

At block S509, the terminal matches the current terminal application information with the application information included in the application modification data string.

In this embodiment, the terminal can match the current terminal application information with the application information included in the application modification data string. It may be understood that, the terminal may match the two by finding whether there is application information that is consistent with the current terminal application information in the application modification data string.

At block S510, when the application information included in the application modification data string matches with the current terminal application information, the terminal modifies function status of the application function based on the function status information included in the application modification data string.

In this embodiment, when the application information included in the application modification data string is matched with the current terminal application information, the terminal can modify the function status of the application function based on the function status information included in the application modification data string. For example, when the current terminal application information is “V2.0” and “Shanghai”, and the application information included in the application modification data string also includes “V2.0” and “Shanghai”, and then the application information included in the application modification data string is matched with the current terminal application information.

In addition, the terminal can modify the function status of the application function based on the function status information included in the application modification data string. For example, when the function status information is “false”, the terminal can modify the function status of the application function to be “false” based on this function status information.

In embodiments of the present disclosure, when the current terminal application information of the terminal application is matched with the application information included in the application modification data string, the terminal modifies the function status of the application function based on the function status information included in the application modification data string, thereby reducing the probability that the terminal modifies the application function in the terminal application in error.

At block S511, when the terminal application information is changed, the terminal sends terminal application update information to the server.

In this embodiment, when the terminal application information is changed, the terminal can send the terminal application update information to the server. It may be understood that, the application update information may be information obtained by the terminal when the application information of the terminal application is changed. For example, when the version information of the terminal application is upgraded from “V2.0” to “V2.1”, and then “V2.1” is configured as the application update information at this moment, and when the location information of the terminal application is changed from “Shanghai” to “Chongqing”, and then “Chongqing” is configured as the application update information at this moment.

In at least one embodiment, the terminal can obtain the current terminal application information every certain time period (for example, every an hour) and send it to the server.

In at least one embodiment, the terminal sends the terminal application update information to the server only when the terminal application information is changed.

At block S512, the server updates the stored terminal application information according to the terminal application update information.

In this embodiment, the server can update the stored terminal application information according to the terminal application update information. For example, the server can replace previously stored version information “V2.0” with the version information “V2.1”, or replace previously stored location information “Shanghai” with the terminal location information “Chongqing”.

In at least one embodiment, when the current terminal application information is not changed compared with the terminal application information stored in the server, the server may not perform the operation on the terminal application information. When the current terminal application information is changed compared with the terminal application information stored in the server, the changed information is configured as the terminal application update information, and the server may update the stored terminal application information according to the terminal application update information.

In embodiments of the present disclosure, the server receives the terminal application update information sent by the terminal and updates the stored terminal application information, so as to prevent the server from sending the application modification data string that is not match with the current terminal application information of the terminal application to the terminal, thus reducing the probability that the server sends the application modification data string in error.

In embodiments of the present disclosure, the server obtains the application function modification information with regard to the terminal application, in which, the application function modification information includes the application function identifier and the application function status information, and generates the application modification data string including the application function identifier and the application function status information, and then sends the application modification data string to the terminal, so that the terminal finds the application function of the terminal application indicated by the application function identifier, and modifies the function status of the application function based on the application function status information. The terminal parses the application modification data string sent by the server, and modifies the state of the application function according to the parsed application function identifier and the application function status information, thereby reducing the operation complexity of changing the state of the application function, and improving the efficiency of changing the state. By matching the terminal application information with the application information in the application modification data string, the server avoids sending the application modification data string to the mismatched terminal, and improves the working efficiency of sending the application modification data string. The server updates the stored terminal application information based on the terminal application update information, so as to avoid sending the application modification data string that is not matched with the current terminal application information of the terminal application to the terminal, thus reducing the probability of sending application modification data string in error. The terminal modifies the function status of the application function based on the function status information only when the current terminal application information of the terminal application is matched with the application information included in the application modification data string, thereby reducing the probability that the terminal modifies the application function in the terminal application in error.

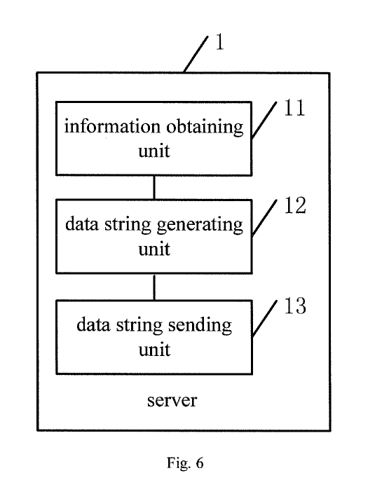

The server provided by embodiments of the present disclosure will be described in detail with reference to accompanying FIG. 6 to FIG. 8. It should be noted that, the server 1 illustrated in FIG. 6 to FIG. 8 is configured to perform the method of embodiments illustrated in FIG. 1 and FIG. 2 of the present disclosure. For ease of description, only the parts related to the embodiments of the present disclosure are illustrated, and specific technical details are not disclosed, which can refer to the embodiments illustrated in FIG. 1 and FIG. 2 of the present disclosure.

Referring to FIG. 6, a block diagram of a server 1 according to embodiments of the present disclosure is illustrated. As illustrated in FIG. 6, the server 1 according to the embodiments of the present disclosure may include an information obtaining unit 11, a data string generating unit 12 and a data string sending unit 13.

The information obtaining unit 11 is configured to obtain application function modification information with regard to a terminal application.

In an implementation, the information obtaining unit 11 can obtain the application function modification information with regard to the terminal application. It may be understood that, the application function modification information may be information for modifying the application function in the terminal application when a background developer upgrades a version of the terminal application or maintains the terminal application. For example, the application function modification information may be information that controls the video chat function in the social application to be enabled, or may be information that controls the weather application function in the social application to be displayed to the user every three hours.

It may be understood that, the application function modification information may include application function identifier and application function status information. The application function identifier may be information that indicates the application function of the terminal application. For example, “weather” may be an application function identifier included in the application function modification information that indicates the weather application function in the social application. The application function status information may be information that represents the state of the application function in the tenninal application. For example, “false” may represent information of a disabled state of the weather application function in the social application, and “show” may represent information of displaying the weather application function in the social application.

The data string generating unit 12 is configured to generate an application modification data string including the application function identifier and the application function status information.

In an implementation, the data string generating unit 12 can generate the application modification data string that includes the application function identifier and the application function status information. It may be understood that, the application modification data string may be a data string that the server 1 sends to the terminal to modify the application function in a corresponding terminal application in the terminal. For example, the application modification data string “social application A, weather, false” may indicate to disable the weather application function in the social application A in the terminal.

In at least one embodiment, the application modification data string may further include application information that indicates the terminal application in the terminal. The application information may be version information that indicates a version of the terminal application, or information that indicates time frequency or change location for changing the state of the application function. For example, the application modification data string “V1.3, social application A, weather, false” that includes the terminal application version information may indicate to disable the weather application function in the social application A with the version 1.3, and the application modification data string “≥1.3, social application A, weather, false” may indicate to disable the weather application function in the social application A with the version higher than or equal to 1.3. The application modification data string “social application A, America, weather, false” that includes the application function change location may indicate to disable the weather application function in the social application A of the American client. The application modification data string “social application A, 3h, weather, show” that includes the application function change time frequency may indicate to display the weather application function every three hours in the social application A.

It should be noted that, a content in the application modification data string may be generated in the format that is agreed with the terminal After the terminal receives the application modification data string, the terminal can parse the data content in the application modification data string.

The data string sending unit 13 is configured to send the application modification data string to a terminal.

In an implementation, the data string sending unit 13 can send the application modification data string to the terminal.

In addition, after the terminal receives the application modification data string, the terminal can find an application function of the terminal application indicated by the application function identifier, and can modify function status of the application function based on the application function status information.

In embodiments of the present disclosure, the server 1 obtains the application function modification information with regard to the terminal application, in which, the application function modification information includes the application function identifier and the application function status information, and generates the application modification data string including the application function identifier and the application function status information, and then sends the application modification data string to the terminal, so that the terminal finds the application function of the terminal application indicated by the application function identifier, and modifies the function status of the application function based on the application function status information. The terminal parses the application modification data string sent by the server 1, and modifies the state of the application function according to the parsed application function identifier and the application function status information, thereby reducing the operation complexity of changing the state of the application function, and improving the efficiency of changing the state.

Referring to FIG. 7, a block diagram of a server 1 according to another embodiment of the present disclosure is illustrated. As illustrated in FIG. 7, the server 1 according the embodiments of the present disclosure may include an information obtaining unit 11, a data string generating unit 12 and a data string sending unit 13, an information receiving unit 14 and an update information receiving unit 15.

The information receiving unit 14 is configured to receive terminal identification information and terminal application information sent by the terminal, and store the terminal identification information and the terminal application information.

In an implementation, the information receiving unit 14 can receive the terminal identification information and the terminal application information sent by the terminal. It may be understood that, the terminal identification information may be the information that can prove the identity of the terminal. For example, the terminal identification information may be user identification information (for example, the access information “ID: XXX” of the terminal device). The terminal application information may be version information of the terminal application, location information of the terminal device located by the terminal application, or the like.

In addition, the information receiving unit 14 can store the terminal identification information and the terminal application information.

The information obtaining unit 11 is configured to obtain application function modification information with regard to a terminal application.

In an implementation, the information obtaining unit 11 can obtain the application function modification information with regard to the terminal application. It may be understood that, the application function modification information may be information for modifying the application function in the terminal application when a background developer upgrades a version of the terminal application or maintains the terminal application. For example, the application function modification information may be information that controls the video chat function in the social application to be enabled, or may be information that controls the weather application function in the social application to be displayed to the user every three hours.

It may be understood that, the application function modification information may include the application function identifier and the application function status information. The application function identifier may be information that indicates the application function of the terminal application. For example, “weather” may be an application function identifier included in the application function modification information that indicates the weather application function in the social application. The application function status information may be information that represents the state of the application function in the terminal application. For example, “false” may represent information of the disabled state of the weather application function in the social application, and “show” may represent information of displaying the weather application function in the social application.

The data string generating unit 12 is configured to generate an application modification data string including the application function identifier and the application function status information.

In an implementation, the data string generating unit 12 can generate the application modification data string that includes the application function identifier and the application function status information. It may be understood that, the application modification data string may be the data string that the server 1 sends to the terminal to modify the application function in a corresponding terminal application in the terminal. For example, the application modification data string “social application A, weather, false” may indicate to disable the weather application function in the social application A in the terminal.

In at least one embodiment, the application modification data string may further include application information that indicates the terminal application in the terminal. The application information may be version information that indicates a version of the terminal application, or information that indicates time frequency or change location for changing the state of the application function. For example, the application modification data string “V1.3, social application A, weather, false” that includes the terminal application version information may indicate to disable the weather application function in the social application A with the version 1.3, and the application modification data string “ V1.3, social application A, weather, false” may indicate to disable the weather application function in the social application A with the version higher than or equal to 1.3. The application modification data string “social application A, America, weather, false” that includes the application function change location may indicate to disable the weather application function in the social application A of the American client. The application modification data string “social application A, 3h, weather, show” that includes the application function change time frequency may indicate to display the weather application function every three hours in the social application A.

It should be noted that, the content in the application modification data string may be generated in the format that is agreed with the terminal. After the terminal receives the application modification data string, the terminal can parse the data content in the application modification data string.

The data string sending unit 13 is configured to send the application modification data string to a terminal.

In an implementation, the data string sending unit 13 can send the application modification data string to the terminal.

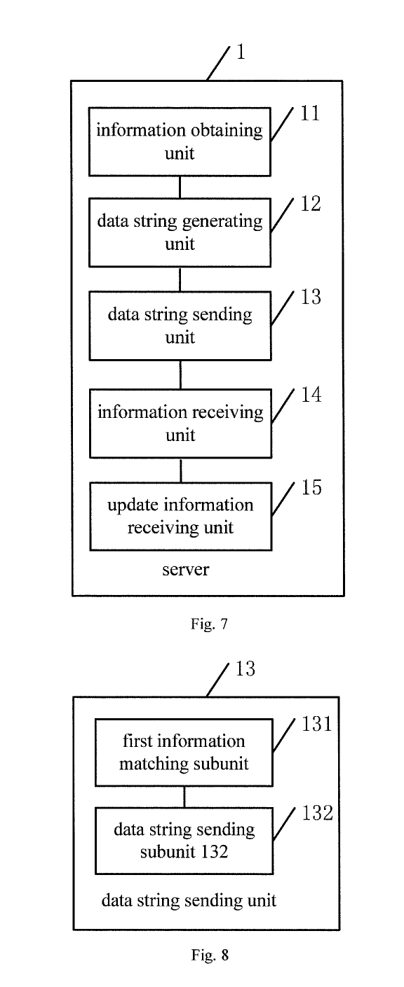

In an embodiment, referring to FIG. 8, a block diagram of a data string sending unit according to an embodiment of the present disclosure is illustrated. As illustrated in FIG. 8, the data string sending unit 13 may include a first information matching subunit 131 and a data string sending subunit 132.

The first information matching subunit 131 is configured to match the terminal application information with the application information included in the application modification data string.

In an implementation, when the application modification data string includes the application information, the first information matching subunit 131 can match the terminal application information with the application information in the application modification data string. It may be understood that, the application modification data string may include application information corresponding to the application function modification information. The application information may be the version information of the terminal application, the terminal location information, or the like. For example, for an application modification data string “V2.0, public service application A, Shanghai, wallet payment, open”, “V2,0” and “Shanghai” can be configured as the application information in the application modification data string.

It may be understood that, the terminal application information may be sent by the terminal and stored by the information receiving unit 14. Since the terminal application information includes at least one of the application version information and the terminal location information, the first information matching subunit 131 may use the terminal application information to match the application information in the application modification data string.

The data string sending subunit 132 is configured to send the application modification data string to the terminal corresponding to the terminal identification information when there is application information matched with the terminal application information in the application modification data string.

In an implementation, when there is the application information matched with the terminal application information in the application modification data string, the data string sending subunit 132 can send the application modification data string to the terminal corresponding to the terminal identification information. For example, when the application version information indicated by the terminal application information is “V2.0” and the terminal location information is “Shanghai”, when the application information in the application modification data string also includes “V2.0” and “Shanghai”, it may indicate that there is the application information matched with the terminal application information in the application modification data string. It may be understood that, the data string sending subunit 132 can send the application modification data string “V2.0, public service application A, Shanghai, wallet payment, open” to the terminal whose user identification information is “ID: XXX”.

In an embodiment of the present disclosure, when the application information in the application modification data string matches with the terminal application information stored in the information receiving unit 14, the data string sending subunit 132 can send the application modification data string to the terminal corresponding to the terminal identification information, so as to avoid sending the application modification data string to the mismatched terminal, thus improving the working efficiency of the server 1 sending the application modification data string.

The update information receiving unit 15 is configured to receive terminal application update information sent by the terminal when the terminal application information is changed, and update the terminal application information according to the terminal application update information.

In an implementation, the update information receiving unit 15 can receive the terminal application update information sent by the terminal when the terminal application information is changed. It may be understood that, the application update information may be information obtained by the terminal when the application information of the terminal application is changed. For example, when the version information of the terminal application is upgraded from “V2.0” to “V2.1”, and then “V2.1” is configured as the application update information at this moment, and when the location information of the terminal application is changed from “Shanghai” to “Chongqing”, and then “Chongqing” is configured as the application update information at this moment.

In addition, the update information receiving unit 15 can update the stored terminal application information according to the terminal application update information. For example, the update information receiving unit 15 can replace previously stored version information “V2.0” with the version information “V2.1”, or replace previously stored location information “Shanghai” with the terminal location information “Chongqing”.

In at least one embodiment, the terminal can obtain the current terminal application information every certain time period (for example, every an hour) and send it to the server 1. When the current terminal application information is not changed compared with the terminal application information stored in the server 1, the update information receiving unit 15 may not perform the operation on the terminal application information. When the current terminal application information is changed compared with the terminal application information stored in the server 1, the changed information is configured as the terminal application update information, and the update information receiving unit 15 may update the stored terminal application information according to the terminal application update information.

In at least one embodiment, the terminal sends the terminal application update information to the server 1 only when the terminal application information is changed, so that the update information receiving unit 15 may update the stored terminal application information according to the terminal application update information.

In embodiments of the present disclosure, the update information receiving unit 15 receives the terminal application update information sent by the terminal and updates the stored terminal application information, so as to prevent the server 1 from sending the application modification data string that is not match with the current terminal application information of the terminal application to the terminal, thus reducing the probability that the server 1 sends the application modification data string in error.

In embodiments of the present disclosure, the server 1 obtains the application function modification information with regard to the terminal application, in which, the application function modification information includes the application function identifier and the application function status information, and generates the application modification data string including the application function identifier and the application function status information, and then sends the application modification data string to the terminal, so that the terminal finds the application function of the terminal application indicated by the application function identifier, and modifies the function status of the application function based on the application function status information. The terminal parses the application modification data string sent by the server 1, and modifies the state of the application function according to the parsed application function identifier and the application function status information, thereby reducing the operation complexity of changing the state of the application function, and improving the efficiency of changing the state. By matching the terminal application information with the application information in the application modification data string, the server 1 avoids sending the application modification data string to the mismatched terminal, and improves the working efficiency of sending the application modification data string. The server 1 updates the stored terminal application information based on the terminal application update information, so as to avoid sending the application modification data string that is not matched with the current terminal application information of the terminal application to the terminal, thus reducing the probability of sending application modification data string in error.

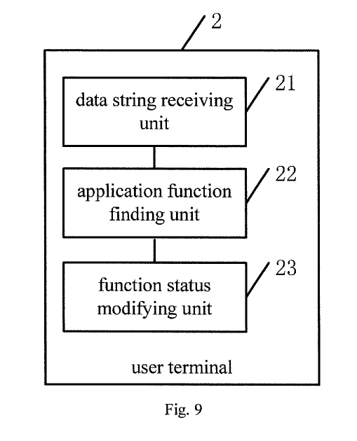

The terminal provided by embodiments of the present disclosure will be described in detail with reference to accompanying FIG. 9 to FIG. 11. It should be noted that, the terminal illustrated in

FIG. 9 to FIG. 11 is configured to perform the method of embodiments illustrated in FIG. 3 and FIG. 4 of the present disclosure. For ease of description, only the parts related to the embodiments of the present disclosure are illustrated, and specific technical details are not disclosed, which can refer to the embodiments illustrated in FIG. 3 and FIG. 4 of the present disclosure.

Referring to FIG. 9, a block diagram of a terminal 2 according to an embodiment of the present disclosure is illustrated. As illustrated in FIG. 9, the terminal 2 according to the embodiments of the present disclosure may include a data string receiving unit 21, an application function finding unit 22 and a function status modifying unit 23.

The data string receiving unit 21 is configured to receive an application modification data string with regard to a terminal application sent by a server 1.

In an implementation, the data string receiving unit 21 can receive the application modification data string with regard to the terminal application sent by the server 1. It may be understood that, the application modification data string may be generated by the server 1 based on the application function identifier and the application function status information. The application function modification information with regard to the terminal application obtained by the server 1 may include the application function identifier and the application function status information.

It may be understood that, the application function modification information may be information for modifying the application function in the terminal application when a background developer upgrades a version of the terminal application or maintains the terminal application. For example, the application function modification information may be information that controls the video chat function in the social application to be enabled, or may be information that controls the weather application function in the social application to be displayed to the user every three hours.

It may be understood that, the application function identifier may be information that indicates the application function of the terminal application. For example, “weather” may be an application function identifier included in the application function modification information that indicates the weather application function in the social application. The application function status information may be information that represents the state of the application function in the terminal application. For example, “false” may represent information of the disabled state of the weather application function in the social application, and “show” may represent information of displaying the weather application function in the social application.

It should be noted that, the content in the application modification data string may be generated in the format that is agreed with the terminal 2. After the terminal 2 receives the application modification data string, the terminal 2 can parse the data content in the application modification data string. For example, from the application modification data string “V1.3, shopping application A, pay, false”, the terminal 2 can parse out content “disabling the payment application function in the shopping application A with the version 1.3”.

The application function finding unit 22 is configured to find an application function of the terminal application indicated by an application function identifier included in the application modification data string.

In an implementation, the application function finding unit 22 can find the application function of the terminal application indicated by the application function identifier included in the application modification data string. It may be understood that, the application function identifier may indicate the application function of the terminal application. For example, the application function identifier “pay” may indicate the payment application function of the shopping application.

The function status modifying unit 23 is configured to modify function status of the application function based on the function status information included in the application modification data string.

In an implementation, the function status modifying unit 23 can modify the function status of the application function based on the function status information included in the application modification data string. For example, when the function status information is “false”, the function status modifying unit 23 can modify the function status of the application function to be “false” based on this function status information.

In embodiments of the present disclosure, the terminal 2 receives the application modification data string with regard to the terminal application sent by the server 1, and finds the application function of the terminal application indicated by the application function identifier included in the application modification data string, and then modifies the function status of the application function based on the function status information included in the application modification data string. The terminal 2 parses the application modification data string sent by the server 1, and modifies the state of the application function according to the parsed application function identifier and the application function status information, thereby reducing the operation complexity of changing the state of the application function, and improving the efficiency of changing the state.

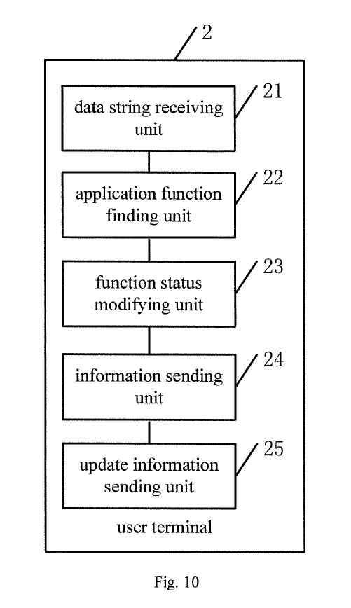

Referring to FIG. 10, a block diagram of a terminal 2 according to another embodiment of the present disclosure is illustrated. As illustrated in FIG. 10, the terminal 2 according to embodiments of the present disclosure may include a data string receiving unit 21, an application function finding unit 22 and a function status modifying unit 23, an information sending unit 24 and an update information sending unit 25.

The information sending unit 24 is configured to send terminal identification information and terminal application information to the server 1.

In an implementation, the information sending unit 24 can send the terminal identification information and the terminal application information to the server 1. It may be understood that, the terminal identification information may be information that can prove the identity of the terminal 2. For example, the terminal identification information may be user identification information (for example, the access information “ID: XXX” of the terminal device). The terminal application information may be the version information of the terminal application, the location information of the terminal located by the terminal application, or the like.

In addition, the server 1 can store the terminal identification information and the terminal application information.

The data string receiving unit 21 is configured to receive an application modification data string with regard to a terminal application sent by the server 1.

In an implementation, the data string receiving unit 21 can receive the application modification data string with regard to the terminal application sent by the server 1. It may be understood that, the application modification data string may be generated by the server 1 based on the application function identifier and the application function status information. The application function modification information with regard to the terminal application obtained by the server 1 may include the application function identifier and the application function status information.

It may be understood that, the application function modification information may be information for modifying the application function in the terminal application when a background developer upgrades a version of the terminal application or maintains the terminal application. For example, the application function modification information may be information that controls the video chat function in the social application to be enabled, or may be information that controls the weather application function in the social application to be displayed to the user every three hours.

It may be understood that, the application function identifier may be information that indicates the application function of the terminal application. For example, “weather” may be an application function identifier included in the application function modification information that indicates the weather application function in the social application. The application function status information may be information that represents the state of the application function in the terminal application. For example, “false” may represent information of the disabled state of the weather application function in the social application, and “show” may represent information of displaying the weather application function in the social application.

It should be noted that, the content in the application modification data string may be generated in the format that is agreed with the terminal 2. After the terminal 2 receives the application modification data string, the terminal 2 can parse the data content in the application modification data string. For example, from the application modification data string “V1.3, shopping application A, pay, false”, the terminal 2 can parse out content “disabling the payment application function in the shopping application A with the version 1.3”.

The application function finding unit 22 is configured to find an application function of the terminal application indicated by an application function identifier included in the application modification data string.

In an implementation, the application function finding unit 22 can find the application function of the terminal application indicated by the application function identifier included in the application modification data string. It may be understood that, the application function identifier may indicate the application function of the terminal application. For example, the application function identifier “pay” may indicate the payment application function of the shopping application.

The function status modifying unit 23 is configured to modify function status of the application function based on the function status information included in the application modification data string.

In an implementation, the function status modifying unit 23 can modify the function status of the application function based on the function status information included in the application modification data string.

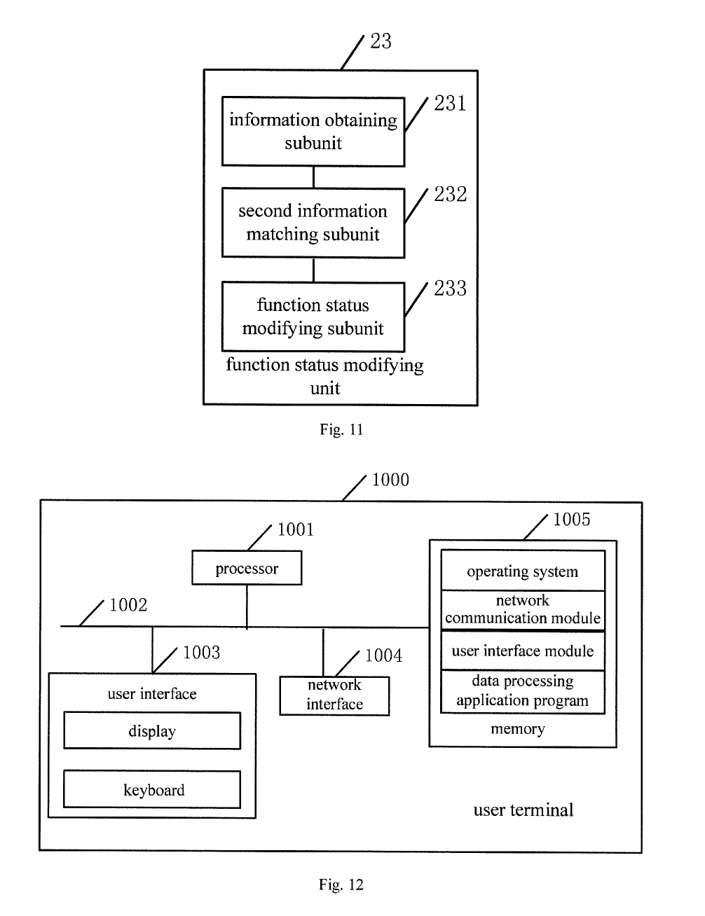

In an embodiment, referring to FIG. 11, a block diagram of a function status modifying unit according to an embodiment of the present disclosure is illustrated. As illustrated in FIG. 11, the function status modifying unit 23 may include an information obtaining subunit 231 and a second information matching subunit 232 and a function status modifying subunit 233.

The information obtaining subunit 231 is configured to obtain current terminal application information of the terminal application corresponding to the terminal identification information.

In an implementation, the information obtaining subunit 231 can obtain the current terminal application information of the terminal application corresponding to the terminal identification information. It may be understood that, the terminal identification information may include the application identifier of the terminal application that identifies the identity of the terminal application (for example, different terminal applications correspond to different package names, and ‘corn. xxx. shejiao’ may be used as the application identifier of the social application).

It may be understood that, when the terminal identification information is the application identifier that indicates the social application A, the information obtaining subunit 231 can obtain current terminal application information of the social application A. The current terminal application information may be the version information of the social application A or the location information of the terminal 2.

The second information matching subunit 232 is configured to match the current terminal application information with the application information included in the application modification data string.

In an implementation, the second information matching subunit 232 can match the current terminal application information with the application information included in the application modification data string. It may be understood that, the second information matching subunit 232 may match the two by fmding whether there is application information that is consistent with the current terminal application information in the application modification data string.

The function status modifying subunit 233 is configured to modify function status of the application function based on the function status information included in the application modification data string when the application information included in the application modification data string matches with the current terminal application information.

In an implementation, when the application information included in the application modification data string is matched with the current terminal application information, the function status modifying subunit 233 can modify the function status of the application function based on the function status information included in the application modification data string. For example, when the current terminal application information is “V2.0” and “Shanghai”, and the application information included in the application modification data string also includes “V2.0” and “Shanghai”, and then the application information included in the application modification data string is matched with the current terminal application information.

In addition, the function status modifying subunit 233 can modify the function status of the application function based on the function status information included in the application modification data string. For example, when the function status information is “false”, the function status modifying subunit 233 can modify the function status of the application function to be “false” based on this function status information.

In embodiments of the present disclosure, when the current terminal application information of the terminal application is matched with the application information included in the application modification data string, the terminal 2 modifies the function status of the application function based on the function status information included in the application modification data string, thereby reducing the probability that the terminal 2 modifies the application function in the terminal application in error.

The update information sending unit 25 is configured to send terminal application update information to the server 1 when the terminal application information is changed.

In an implementation, when the terminal application information is changed, the update information sending unit 25 can send the changed terminal application update information to the server 1. It may be understood that, the application update information may be information obtained by the terminal 2 when the application information of the terminal application is changed. For example, when the version information of the terminal application is upgraded from “V2.0” to “V2.1”, and then “V2.1” is configured as the application update information at this moment, and when the location information of the terminal application is changed from “Shanghai” to “Chongqing”, and then “Chongqing” is configured as the application update information at this moment.

In addition, the server 1 can update the stored terminal application information according to the terminal application update information. For example, the server 1 can replace previously stored version information “V2.0” with the version information “V2.1”, or replace previously stored location information “Shanghai” with the terminal location information “Chongqing”.

In at least one embodiment, the terminal 2 can obtain the current terminal application information every certain time period (for example, every an hour) and send it to the server 1. When the current terminal application information is not changed compared with the terminal application information stored in the server 1, the server 1 may not perform the operation on the terminal application information. When the current terminal application information is changed compared with the terminal application information stored in the server 1, the changed information is configured as the terminal application update information, and the server 1 may update the stored terminal application information according to the terminal application update information.

In at least one embodiment, the terminal 2 sends the terminal application update information to the server 1 only when the terminal application information is changed, so that the server 1 may update the stored terminal application information according to the terminal application update information.

In embodiments of the present disclosure, the update information sending unit 25 sends the terminal application update information to the server 1, so that the server 1 can update the stored terminal application information, thereby preventing the server 1 from sending the application modification data string that is not matched with the current terminal application information of the terminal application to the terminal 2, and reducing the probability that the server 1 sends the application modification data string in error.

In embodiments of the present disclosure, the terminal 2 receives the application modification data string with regard to the terminal application sent by the server 1, and fmds the application function of the terminal application indicated by the application function identifier included in the application modification data string, and then modifies the function status of the application function based on the function status information included in the application modification data string. The terminal 2 parses the application modification data string sent by the server 1, and modifies the state of the application function according to the parsed application function identifier and the application function status information, thereby reducing the operation complexity of changing the state of the application function and improving the efficiency of changing the state. The terminal 2 modifies the function status of the application function based on the function status information only when the current terminal application information of the terminal application is matched with the application information included in the application modification data string, thereby reducing the probability that the terminal 2 modifies the application function in the terminal application in error. The terminal 2 sends the terminal application update information to the server 1, so that the server 1 can update the stored terminal application information, thereby preventing the server 1 from sending the application modification data string that is not matched with the current terminal application information of the terminal application to the terminal 2, and reducing the probability that the server 1 sends the application modification data string in error.

Referring to FIG. 12, a block diagram of a terminal 1000 according to another embodiment of the present disclosure is illustrated. As illustrated in FIG. 12, the terminal 1000 may include at least one processor 1001, such as a CPU, at least one network interface 1004, a user interface 1003, a memory 1005, and at least one communication bus 1002.The communication bus 1002 is configured to implement connection and communication among these components. The user interface 1003 may include a display and a keyboard. Alternatively, the user interface 1003 may further include a standard wired interface and a wireless interface. Alternatively, the network interface 1004 may include a standard wired interface, a wireless interface (such as a WI-FI interface). The memory 1005 may be a high-speed RAM or a non-volatile memory, such as at least one disk memory. Alternatively, the memory 1005 may also be at least one storage device located remotely from the processor 1001. As illustrated in FIG. 12, as a computer storage medium, the memory 1005 may include an operating system, a network communication module, a user interface module and a data processing application program.

In the terminal 1000 illustrated in FIG. 12, the user interface 1003 is mainly configured to provide an input interface to the user and obtain data input by the user. The network interface 1004 is configured to perform a data communication with the terminal 1000. The processor 1001 may be configured to call the data processing application program stored in the memory 1005, and perform operations: receiving an application modification data string with regard to a terminal application sent by a server; finding an application function of the terminal application indicated by an application function identifier included in the application modification data string; and modifying function status of the application function based on function status information included in the application modification data string.

In an embodiment, before the processor 1001 performs the operation of receiving the application modification data string with regard to the terminal application sent by the server, the processor 1001 further performs an operation of sending terminal identification information and terminal application information to the server, so that the server stores the terminal identification information and the terminal application information.

The terminal application information includes at least one of application version information and terminal location information.

In an embodiment, the application modification data string further includes application information.

When the processor 1001 performs the operation of modifying function status of the application function based on the function status information included in the application modification data string, the processor 1001 specifically performs operations of obtaining current terminal application information of the terminal application corresponding to the terminal identification information; matching the current terminal application information with the application information included in the application modification data string; and modifying function status of the application function based on the function status information included in the application modification data string when the application information included in the application modification data string matches with the current terminal application information.

In an embodiment, the processor 1001 is further configured to perform operations: when the terminal application information is changed, sending terminal application update information to the server, so that the server updates the terminal application information according to the terminal application update information.

In embodiments of the present disclosure, the terminal 1000 receives the application modification data string with regard to the terminal application sent by the server, and finds the application function of the terminal application indicated by the application function identifier included in the application modification data string, and then modifies the function status of the application function based on the function status information included in the application modification data string. The terminal 1000 parses the application modification data string sent by the server, and modifies the state of the application function according to the parsed application function identifier and the application function status information, thereby reducing the operation complexity of changing the state of the application function, and improving the efficiency of changing the state. The terminal 1000 modifies the function status of the application function based on the function status information only when the current terminal application information of the terminal application is matched with the application information included in the application modification data string, thereby reducing the probability that the terminal 1000 modifies the application function in the terminal application in error. The terminal 1000 sends the terminal application update information to the server, so that the server can update the stored terminal application information, thereby preventing the server from sending the application modification data string that is not matched with the current terminal application information of the terminal application to the terminal 1000, and reducing the probability that the server sends the application modification data string in error.

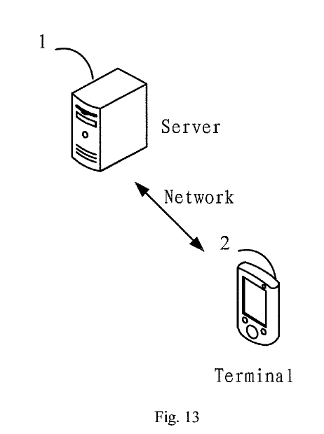

Referring to FIG. 13, a block diagram of a data processing system according to an embodiment of the present disclosure is illustrated. As illustrated in FIG. 13, the system may include a server 1 and a terminal 2. The server 1 and the terminal 2 may be connected to each other through a network. The server 1 is the server 1 in any one of the embodiments illustrated in FIG. 6 to FIG. 8. The terminal 2 is the terminal 2 in any one of the embodiments illustrated in FIG. 9 to FIG. 11, or the terminal 2 may be the terminal 1000 in the embodiments illustrated in FIG. 12.

The server 1 is configured to obtain application function modification information with regard to a terminal application.

The server 1 is further configured to generate an application modification data string including application function identifier and application function status information.

The server 1 is configured to send the application modification data string to a terminal 2, so that the terminal 2 finds an application function of the terminal application indicated by the application function identifier, and modifies function status of the application function based on the application function status information.

In an embodiment, the server 1 is further configured to receive terminal identification information and terminal application information sent by the terminal 2, and store the terminal identification information and the terminal application information.

The terminal application information includes at least one of application version information and terminal location information.

In an embodiment, the application modification data string further includes application information.

The server 1 is further configured to match the terminal application information with the application information included in the application modification data string.

When there is application information matched with the terminal application information in the application modification data string, the server 1 is further configured to send the application modification data string to the terminal 2 corresponding to the terminal identification information.

In an embodiment, the server 1 is further configured to receive terminal application update information sent by the terminal 2 when the terminal application information is changed, and update the terminal application information according to the terminal application update information.

The terminal 2 is configured to receive an application modification data string with regard to a terminal application sent by a server 1.

The terminal 2 is further configured to fmd an application function of the terminal application indicated by an application function identifier included in the application modification data string.

The terminal 2 is further configured to modify function status of the application function based on the function status information included in the application modification data string.

In an embodiment, the terminal 2 is further configured to send terminal identification information and terminal application information to the server 1, so that the server 1 stores the terminal identification information and the terminal application information.

The terminal application information includes at least one of application version information and terminal location information.

In an embodiment, the application modification data string further includes application information.

The terminal 2 is further configured to obtain current terminal application information of the terminal application corresponding to the terminal identification information.

The terminal 2 is further configured to match the current terminal application information with the application information included in the application modification data string.

The terminal 2 is further configured to modify function status of the application function based on the function status information included in the application modification data string when the application information included in the application modification data string matches with the current terminal application information.

In an embodiment, the terminal 2 is further configured to send terminal application update information to the server 1 when the terminal application information is changed, so that the server 1 updates the terminal application information according to the terminal application update information.

In embodiments of the present disclosure, the server 1 obtains the application function modification information with regard to the terminal application, in which, the application function modification information includes the application function identifier and the application function status information, and generates the application modification data string including the application function identifier and the application function status information, and then sends the application modification data string to the terminal 2, so that the terminal 2 finds the application function of the terminal application indicated by the application function identifier, and modifies the function status of the application function based on the application function status information. The terminal 2 parses the application modification data string sent by the server 1, and modifies the state of the application function according to the parsed application function identifier and the application function status information, thereby reducing the operation complexity of changing the state of the application function, and improving the efficiency of changing the state. By matching the terminal application information with the application information in the application modification data string, the server 1 avoids sending the application modification data string to the mismatched terminal, and improves the working efficiency of sending the application modification data string. The server 1 updates the stored terminal application information based on the terminal application update information, so as to avoid sending the application modification data string that is not matched with the current terminal application information of the terminal application to the terminal 2, thus reducing the probability of sending application modification data string in error. The terminal 2 modifies the function status of the application function based on the function status information only when the current terminal application information of the terminal application is matched with the application information included in the application modification data string, thereby reducing the probability that the terminal 2 modifies the application function in the terminal application in error.

It would be understood by those skilled in the art that all or a part of the steps carried by the method in the above-described embodiments may be completed by relevant hardware instructed by a program. The program may be stored in a computer readable storage medium. When the program is executed, one or a combination of the steps of the method in the above-described embodiments may be included. The storage medium may be a magnetic disk, an optical disk, a read-only memory (ROM), a random access memory (RAM), or the like.

The above disclosure is only preferred embodiments of the present disclosure, and certainly cannot be used to limit the scope of the present disclosure. Therefore, any equivalent changes made according to the claims of the present disclosure are still within the scope of the present disclosure.

What is claimed is:

1. A data processing method, comprising:
obtaining application function modification information with regard to a terminal application, wherein, the application function modification information comprises an application function identifier and application function status information;
generating an application modification data string comprising the application function identifier and the application function status information; and
sending the application modification data string to a terminal, so that the terminal fmds an application function of the terminal application indicated by the application function identifier, and modifies function status of the application function based on the application function status information.

2. The method according to claim 1, before obtaining application function modification information with regard to the terminal application, further comprising:
receiving terminal identification information and terminal application information sent by the terminal, and storing the terminal identification information and the terminal application information; wherein, the terminal application information comprises at least one of application version information and terminal location information.

3. The method according to claim 2, wherein, the application modification data string further comprises application information;
sending the application modification data string to the terminal comprises:
matching the terminal application information with the application information included in the application modification data string; and
when there is application information matched with the terminal application information in the application modification data string, sending the application modification data string to the terminal corresponding to the terminal identification information.

4. The method according to claim 3, wherein the application information comprises at least one of version information indicating a version of the terminal application, location information located by the application function and information indicating time frequency or change location for changing the function status of the application function.

5. The method according to claim 3, further comprising:
receiving terminal application update information sent by the terminal when the terminal application information is changed, and updating the terminal application information according to the terminal application update information.

6. A data processing method, comprising:
receiving an application modification data string with regard to a terminal application sent by a server;
finding an application function of the terminal application indicated by an application function identifier comprised in the application modification data string; and
modifying function status of the application function based on function status information comprised in the application modification data string.

7. The method according to claim 6, before receiving the application modification data string with regard to the terminal application sent by the server, further comprising:
sending terminal identification information and terminal application information to the server, so that the server stores the terminal identification information and the terminal application information; wherein, the terminal application information comprises at least one of application version information and terminal location information.

8. The method according to claim 7, wherein, the application modification data string further comprises application information;
modifying function status of the application function based on the function status information comprised in the application modification data string comprises:
obtaining current terminal application information of the terminal application corresponding to the terminal identification information;
matching the current terminal application information with the application information comprised in the application modification data string; and
when the application information comprised in the application modification data string matches with the current terminal application information, modifying function status of the application function based on the function status information comprised in the application modification data string.

9. The method according to claim 8, wherein the application information comprises at least one of version information indicating a version of the terminal application, location information located by the application function and information indicating time frequency or change location for changing the function status of the application function.

10. The method according to claim 6, further comprising:
when the terminal application information is changed, sending terminal application update information to the server, so that the server updates the terminal application information according to the terminal application update information.

11. A server, wherein the server comprises a non-transitory computer-readable medium comprising computer-executable instructions stored thereon, and an instruction execution system which is configured by the computer-executable instructions to implement at least one of:
an information obtaining unit, configured to obtain application function modification information with regard to a terminal application, wherein, the application function modification information comprises an application function identifier and application function status information;
a data string generating unit, configured to generate an application modification data string comprising the application function identifier and the application function status information; and
a data string sending unit, configured to send the application modification data string to a terminal, so that the terminal finds an application function of the terminal application indicated by the application function identifier, and modifies function status of the application function based on the application function status information.

12. The server according to claim 11, wherein the instruction execution system is further configured by the computer-executable instructions to implement:
an information receiving unit, configured to receive terminal identification information and terminal application information sent by the terminal, and store the terminal identification information and the terminal application information; wherein, the terminal application information comprises at least one of application version information and terminal location information.

13. The server according to claim 12, wherein, the application modification data string further comprises application information;
the data string sending unit comprises:
a first information matching subunit, configured to match the terminal application information with the application information included in the application modification data string; and
a data string sending subunit, configured to send the application modification data string to the terminal corresponding to the terminal identification information when there is the application information matched with the terminal application information in the application modification data string.

14. The server according to claim 13, wherein the application information comprises at least one of version information indicating a version of the terminal application, location information located by the application function and information indicating time frequency or change location for changing the function status of the application function.

15. The server according to claim 13, wherein the instruction execution system is further configured by the computer-executable instructions to implement:
an update information receiving unit, configured to receive terminal application update information sent by the terminal when the terminal application information is changed, and to update the terminal application information according to the terminal application update information.

16. A terminal, wherein the terminal comprises a non-transitory computer-readable medium comprising computer-executable instructions stored thereon, and an instruction execution system which is configured by the computer-executable instructions to implement at least one of
a data string receiving unit, configured to receive an application modification data string with regard to a terminal application sent by a server;
an application function finding unit, configured to find an application function of the terminal application indicated by an application function identifier comprised in the application modification data string; and
a function status modifying unit, configured to modify function status of the application function based on function status information comprised in the application modification data string.

17. The terminal according to claim 16, wherein the instruction execution system is further configured by the computer-executable instructions to implement:
an information sending unit, configured to send terminal identification information and terminal application information to the server, so that the server stores the terminal identification information and the terminal application information; wherein, the terminal application information comprises at least one of application version information and terminal location information.

18. The terminal according to claim 17, the application modification data string further comprises application information;
the function status modifying unit comprises:
an information obtaining subunit, configured to obtain current terminal application information of the terminal application corresponding to the terminal identification information;
a second information matching subunit, configured to match the current terminal application information with the application information comprised in the application modification data string; and
a function status modifying subunit, configured to modify function status of the application function based on the function status information comprised in the application modification data string when the application information comprised in the application modification data string matches with the current terminal application information.

19. The terminal according to claim 18, wherein the application information comprises at least one of version information indicating a version of the terminal application, location information located by the application function and information indicating time frequency or change location for changing the function status of the application function.

20. The terminal according to claim 16, wherein the instruction execution system is further configured by the computer-executable instructions to implement:
an update information sending unit, configured to send terminal application update information to the server when the terminal application information is changed, so that the server updates the terminal application information according to the terminal application update information.
